(19) United States
(12) Patent Application Publication
(10) Pub. No.: US 2008/0171660 A1
(43) Pub. Date: Jul. 17, 2008

(54) Method of Controlling Weeds

(76) Inventors: Dan E. Westberg, Cary, NC (US); Gary Fellows, Apex, NC (US); Glen W. Oliver, Apex, NC (US); Mark Oostlander, Lethbridge (CA); Lyle Drew, Regina (CA); Nathan Froese, Winkler (CA); Glen Forster, Saskatoon (CA); Roy Killins, Gueleph (CA); Max Landes, Visalia, CA (US)

Correspondence Address: HUTCHISON LAW GROUP PLLC, PO BOX 31686, RALEIGH, NC, 27612, US

(21) Appl. No.: 11/996,989

(22) PCT Filed: Aug. 1, 2006
(86) PCT No.: PCT/EP2006/007616

§ 371 Date: Feb. 22, 2008

Related U.S. Application Data
(60) Provisional application No. 60/703,893, filed on Aug. 1, 2005.

(51) Int. Cl. A01N 43/54; A01N 47/36; A01N 25/32; A01P 13/02

(52) U.S. Cl. 504/105; 504/136

(57) ABSTRACT

The present invention relates to the use of 3-phenyluracils of formula (I) wherein the variables R¹ to R⁷ are as defined in the description, in combination with tribenuron and optionally one or more other herbicides for controlling weeds in small-grain cereals.

The present invention relates to a method of controlling weeds in small grain cereals.

Efficient weed control in small-grain cereals such as wheat, oat, barley or rye is of great economic importance.

Phenyluracils are known to be useful herbicides. WO 04/080183 discloses combinations of said phenyluracils with certain other herbicides having increased herbicidal activity and improved compatibility with useful plants. The use of herbicidal phenyluracils as desiccants and/or defoliants is disclosed in WO 01/83459. Furthermore, it is known from WO 03/24221 that combinations comprising phenyluracils of formula I

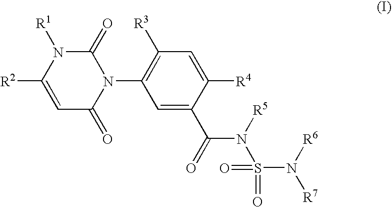

in which the variables R¹-R⁷ are as defined below:
R¹ is methyl or NH₂;
R² is C₁-C₂-haloalkyl;
R³ is hydrogen or halogen;
R⁴ is halogen or cyano;
R⁵ is hydrogen, cyano, C₁-C₆-alkyl, C₁-C₆-alkoxy, C₁-C₄-alkoxy-C₁-C₄-alkyl, C₃-C₇-cycloalkyl, C₃-C₆-alkenyl, C₃-C₆-alkynyl or benzyl which is unsubstituted or substituted by halogen or alkyl;
R⁶, R⁷ independently of one another are hydrogen, C₁-C₆-alkyl, C₁-C₆-alkoxy, C₃-C₆-alkenyl, C₃-C₆-alkynyl, C₃-C₇-cycloalkyl, C₃-C₇-cycloalkenyl, phenyl or benzyl, where each of the 8 abovementioned substituents is unsubstituted or may be substituted by 1 to 6 halogen atoms and/or by one, two or three groups selected from: OH, NH₂, CN, CONH₂, C₁-C₄-alkoxy, C₁-C₄-haloalkoxy, C₁-C₄-alkylthio, C₁-C₄-haloalkylthio, C₁-C₄-alkylsulfonyl, C₁-C₄-haloalkylsulfonyl, C₁-C₄-alkylamino, di(C₁-C₄-alkyl)amino, formyl, C₁-C₄-alkylcarbonyl, C₁-C₄-alkoxycarbonyl, C₁-C₄-alkylaminocarbonyl, di(C₁-C₄-alkyl)aminocarbonyl, C₃-C₇-cycloalkyl, phenyl and benzyl; or
R⁶, R⁷ together with the nitrogen atom form a 3-, 4-, 5-, 6- or 7-membered saturated or unsaturated nitrogen heterocycle which may be substituted by 1 to 6 methyl groups and which may contain 1 or 2 further heteroatoms selected from the group consisting of nitrogen, oxygen and sulfur as ring members.
   or their agriculturally acceptable salts, and other herbicides including ALS inhibitors, such as tribenuron and/or certain safeners exhibit synergistically enhanced activity. Tribenuron, in particular in the form of its methyl ester called tribenuron-methyl, is a commercial herbicide. Tribenuron has the formula

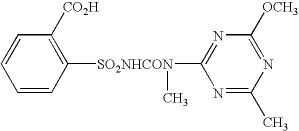

Tribenuron is selective in small-grain cereals. At higher use rates phenyluracils have phytotoxity in small-grain cereals. In view of their synergistically enhanced activity with ALS inhibitors one would expect an even higher phytotoxity when using a combination of phenyluracils with tribenuron.

Surprisingly, it has now been found that phenyluracils or agriculturally acceptable salts thereof, in combination with tribenuron exhibit reduced phytotoxity in small grain cereal crops. Thus, tribenuron has a crop specific safening effect on phenyluracils of formula I.

The present invention therefore relates to a method of controlling weeds in crops selected from small grain cereals which comprises allowing an herbicidally effective amount of a combination of 3-phenyluracil of formula I (component A)

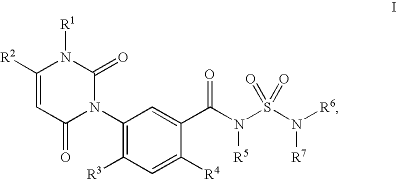

wherein the variables R¹ to R⁷ are as defined below:
R¹ is methyl or NH₂;
R² is C₁-C₂-haloalkyl;
R³ is hydrogen or halogen;
R⁴ is halogen or cyano;
R⁵ is hydrogen or C₁-C₆-alkyl;
R⁶, R⁷ independently of one another are hydrogen, C₁-C₆-alkyl, C₁-C₆-alkoxy, C₃-C₆-alkenyl, C₃-C₆-alkynyl, C₃-C₇-cycloalkyl, C₃-C₇-cycloalkenyl, phenyl or benzyl;
   or an agriculturally acceptable salt thereof, with tribenuron, an agriculturally acceptable derivative thereof or an agriculturally acceptable salt thereof (component B) to act on the crops or weeds or their habitat.

Habitat means the living space of the plants.

The organic moieties mentioned in the definition of the substituents R², R⁵, R⁶, R⁷ in formula I are—like the term halogen—collective terms for individual enumerations of the individual group members. All hydrocarbon chains, i.e. all alkyl, haloalkyl, cycloalkyl, alkoxy, cycloalkenyl, alkenyl and alkynyl groups can be straight-chain or branched, the prefix Cₙ-Cₘ denoting in each case the possible number of carbon atoms in the group. Halogenated substituents preferably carry one, two, three, four or five identical or different halogen atoms. The term halogen denotes in each case fluorine, chlorine, bromine or iodine.

Examples of such meanings are:
C₁-C₄-alkyl: CH₃, C₂H₅, n-propyl, CH(CH₃)₂, n-butyl, CH(CH₃)—C₂H₅, CH₂—CH(CH₃)₂ and C(CH₃)₃;
C₁-C₆-alkyl: C₁-C₄-alkyl as mentioned above, and also, for example, n-pentyl, 1-methylbutyl, 2-methylbutyl, 3-methylbutyl, 2,2-dimethylpropyl, 1-ethylpropyl, n-hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl or 1-ethyl-2-methylpropyl, preferably methyl, ethyl, n-propyl, 1-methylethyl, n-butyl, 1,1-dimethylethyl, n-pentyl or n-hexyl;
C₁-C₂-haloalkyl: a methyl or ethyl radical, which is partially or fully substituted by fluorine, chlorine, bromine and/or iodine, for example CH₂F, CHF₂, CF₃, CH₂Cl, dichloromethyl, trichloromethyl, chlorofluormethyl, dichlorofluoromethyl, chlorodifluoromethyl, 2-fluoroethyl, 2-chloroethyl, 2-brom-oethyl, 2-iodoethyl, 2,2-difluoroethyl, 2,2,2-trifluoroethyl, 2-chloro-2-fluor-oethyl, 2-chloro-2,2-difluoroethyl, 2,2-dichloro-2-fluoroethyl, 2,2,2-tri-chloroethyl, C₂F₅;
C₁-C₄-alkoxy: OCH₃, OC₂H₅, n-propoxy, OCH(CH₃)₂, n-butoxy, OCH(CH₃)—C₂H₅, OCH₂—CH(CH₃)₂ or OC(CH₃)₃, preferably OCH₃, OC₂H₅ or OCH(CH₃)₂;
C₁-C₆-alkoxy: a C₁-C₄-alkoxy radical as mentioned above, and also, for example pentoxy, 1-methylbutoxy, 2-methylbutoxy, 3-methoxylbutoxy, 1,1-dimethylpropoxy, 1,2-dimethylpropoxy, 2,2-dimethylpropoxy, 1-ethylpropoxy, hexoxy, 1-methylpentoxy, 2-methylpentoxy, 3-methylpentoxy, 4-methylpentoxy, 1,1-dimethylbutoxy, 1,2-dimethylbutoxy, 1,3-dimethylbutoxy, 2,2-dimethylbutoxy, 2,3-dimethylbutoxy, 3,3-dimethylbutoxy, 1-ethylbutoxy, 2-ethylbutoxy, 1,1,2-trimethylpropoxy, 1,2,2-trimethylpropoxy, 1-ethyl-1-methylpropoxy and 1-ethyl-2-methylpropoxy;
C₃-C₆-alkenyl: prop-1-en-1-yl, allyl, 1-methylethenyl, 1-buten-1-yl, 1-buten-2-yl, 1-buten-3-yl, 2-buten-1-yl, 1-methylprop-1-en-1-yl, 2-methylprop-1-en-1-yl, 1-methylprop-2-en-1-yl, 2-methylprop-2-en-1-yl, n-penten-1-yl, n-penten-2-yl, n-penten-3-yl, n-penten-4-yl, 1-methylbut-1-en-1-yl, 2-methylbut-1-en-1-yl, 3-methylbut-1-en-1-yl, 1-methylbut-2-en-1-yl, 2-methylbut-2-en-1-yl, 3-methylbut-2-en-1-yl, 1-methylbut-3-en-1-yl, 2-methylbut-3-en-1-yl, 3-methylbut-3-en-1-yl, 1,1-dimethylprop-2-en-1-yl, 1,2-dimethylprop-1-en-1-yl, 1,2-dimethylprop-2-en-1-yl, 1-ethylprop-1-en-2-yl, 1-ethylprop-2-en-1-yl, n-hex-1-en-1-yl, n-hex-2-en-1-yl, n-hex-3-en-1-yl, n-hex-4-en-1-yl, n-hex-5-en-1-yl, 1-methylpent-1-en-1-yl, 2-methylpent-1-en-1-yl, 3-methylpent-1-en-1-yl, 4-methylpent-1-en-1-yl, 1-methylpent-2-en-1-yl, 2-methylpent-2-en-1-yl, 3-methylpent-2-en-1-yl, 4-methylpent-2-en-1-yl, 1-methylpent-3-en-1-yl, 2-methylpent-3-en-1-yl, 3-methylpent-3-en-1-yl, 4-methylpent-3-en-1-yl, 1-methylpent-4-en-1-yl, 2-methylpent-4-en-1-yl, 3-methylpent-4-en-1-yl, 4-methylpent-4-en-1-yl, 1,1-dimethylbut-2-en-1-yl, 1,1-dimethylbut-3-en-1-yl, 1,2-dimethylbut-1-en-1-yl, 1,2-dimethylbut-2-en-1-yl, 1,2-dimethylbut-3-en-1-yl, 1,3-dimethylbut-1-en-1-yl, 1,3-dimethylbut-2-en-1-yl, 1,3-dimethylbut-3-en-1-yl, 2,2-dimethylbut-3-en-1-yl, 2,3-dimethylbut-1-en-1-yl, 2,3-dimethylbut-2-en-1-yl, 2,3-dimethylbut-3-en-1-yl, 3,3-dimethylbut-1-en-1-yl, 3,3-dimethylbut-2-en-1-yl, 1-ethylbut-1-en-1-yl, 1-ethylbut-2-en-1-yl, 1-ethylbut-3-en-1-yl, 2-ethylbut-1-en-1-yl, 2-ethylbut-2-en-1-yl, 2-ethylbut-3-en-1-yl, 1,1,2-trimethylprop-2-en-1-yl, 1-ethyl-1-methylprop-2-en-1-yl, 1-ethyl-2-methylprop-1-en-1-yl or 1-ethyl-2-methylprop-2-en-1-yl;
C₃-C₆-alkynyl: prop-1-yn-1-yl, prop-2-yn-1-yl, n-but-1-yn-1-yl, n-but-1-yn-3-yl, n-but-1-yn-4-yl, n-but-2-yn-1-yl, n-pent-1-yn-1-yl, n-pent-1-yn-3-yl, n-pent-1-yn-4-yl, n-pent-1-yn-5-yl, n-pent-2-yn-1-yl, n-pent-2-yn-4-yl, n-pent-2-yn-5-yl, 3-methylbut-1-yn-3-yl, 3-methylbut-1-yn-4-yl, n-hex-1-yn-1-yl, n-hex-1-yn-3-yl, n-hex-1-yn-4-yl, n-hex-1-yn-5-yl, n-hex-1-yn-6-yl, n-hex-2-yn-1-yl, n-hex-2-yn-4-yl, n-hex-2-yn-5-yl, n-hex-2-yn-6-yl, n-hex-3-yn-1-yl, n-hex-3-yn-2-yl, 3-methylpent-1-yn-1-yl, 3-methylpent-1-yn-3-yl, 3-methylpent-1-yn-4-yl, 3-methylpent-1-yn-5-yl, 4-methylpent-1-yn-1-yl, 4-methylpent-2-yn-4-yl or 4-methylpent-2-yn-5-yl, preferably prop-2-yn-1-yl;
C₃-C₇-cycloalkyl: a monocyclic saturated hydrocarbon ring having 3 to 7 ring members, such as cyclopropyl, cyclobutyl, cyclopentyl, cyclohexyl or cycloheptyl;
C₃-C₇-cycloalkenyl: monocyclic unsaturated hydrocarbon ring having 3 to 7 ring members, such as cycloprop-1-enyl, cycloprop-2-enyl, cyclobut-1-enyl, cyclobut-2-enyl, cyclobut-1,3-dienyl, cyclopent-1-enyl, cyclopent-2-enyl, cyclopent-3-enyl, cyclopent-2,4-dienyl, cyclohex-1-enyl, cyclohex-2-enyl, cyclohex-3-enyl; cyclohex-1,3-dienyl, cyclohex-1,5-dienyl, cyclohex-2,4-dienyl, or cyclohex-2,5-dienyl.

One or more 3-phenyluracils may be used.

Among the 3-phenyluracils of formula I, preference is given to those wherein the variables R¹ to R⁷ independently of one another, have the meanings given below:
R¹ is methyl or NH₂;
R² is trifluoromethyl;
R³ is hydrogen, fluorine or chlorine,
   in particular fluorine;
R⁴ is halogen or cyano,
   in particular chlorine or cyano;
R⁵ is hydrogen;
R⁶, R⁷ independently of one another are hydrogen or C₁-C₆-alkyl.
R⁶ and R⁷ are in particular identical or different C₁-C₆-alkyl radicals.

A particularly preferred embodiment of the invention comprises the use of at least one 3-phenyluracil I in which the variables R¹ to R⁷ in formula I have the following meanings (hereinbelow also referred to as phenyluracils Ia):
R¹ is methyl;
R² is trifluoromethyl;
R³ is fluorine;
R⁴ is chlorine;
R⁵ is hydrogen;
R⁶, R⁷ independently of one another are C₁-C₆-alkyl.

Another particularly preferred embodiment of the invention comprises the use at least one 3-phenyluracil I in which the variables R¹ to R⁷ in formula I have the meanings below (hereinbelow also referred to as phenyluracils Ib):
R¹ is NH₂;
R² is trifluoromethyl;
R³ is fluorine;
R⁴ is chlorine;
R⁵ is hydrogen;
R⁶, R⁷ independently of one another are C₁-C₆-alkyl.

Examples of particularly preferred herbicides Ia or Ib are the 3-phenyluracils of the formula I′ listed below wherein R¹, R⁶ and R⁷ have the meanings given in one row of table 1 (compounds I.1 to I.74).

TABLE 1

| | |
|---|---|
| | I′ |
| 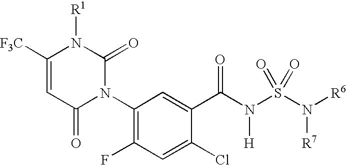 | |

| 3-phenyluracil I | R¹ | R⁶ | R⁷ |
|---|---|---|---|
| I.1 | methyl | methyl | methyl |
| I.2 | amino | methyl | methyl |
| I.3 | methyl | methyl | ethyl |
| I.4 | amino | methyl | ethyl |
| I.5 | methyl | methyl | propyl |
| I.6 | amino | methyl | propyl |
| I.7 | methyl | methyl | isopropyl |
| I.8 | amino | methyl | isopropyl |
| I.9 | methyl | methyl | butyl |
| I.10 | amino | methyl | butyl |
| I.11 | methyl | methyl | s-butyl |
| I.12 | amino | methyl | s-butyl |
| I.13 | methyl | methyl | isobutyl |
| I.14 | amino | methyl | isobutyl |
| I.15 | methyl | methyl | t-butyl |
| I.16 | amino | methyl | t-butyl |
| I.17 | methyl | methyl | n-pentyl |
| I.18 | amino | methyl | n-pentyl |
| I.19 | methyl | methyl | n-hexyl |
| I.20 | amino | methyl | n-hexyl |
| I.21 | methyl | methyl | allyl |
| I.22 | amino | methyl | allyl |
| I.23 | methyl | methyl | propargyl |
| I.24 | amino | methyl | propargyl |
| I.25 | methyl | methyl | phenyl |
| I.26 | amino | methyl | phenyl |
| I.27 | methyl | methyl | benzyl |
| I.28 | amino | methyl | benzyl |
| I.29 | methyl | ethyl | ethyl |
| I.30 | amino | ethyl | ethyl |
| I.31 | methyl | ethyl | propyl |
| I.32 | amino | ethyl | propyl |
| I.33 | methyl | ethyl | isopropyl |
| I.34 | amino | ethyl | isopropyl |
| I.35 | methyl | ethyl | butyl |
| I.36 | amino | ethyl | butyl |
| I.37 | methyl | ethyl | n-pentyl |
| I.38 | amino | ethyl | n-pentyl |
| I.39 | methyl | ethyl | n-hexyl |
| I.40 | amino | ethyl | n-hexyl |
| I.41 | methyl | propyl | propyl |
| I.42 | amino | propyl | propyl |
| I.43 | methyl | propyl | isopropyl |
| I.44 | amino | propyl | isopropyl |
| I.45 | methyl | propyl | butyl |
| I.46 | amino | propyl | butyl |
| I.47 | methyl | propyl | n-pentyl |
| I.48 | amino | propyl | n-pentyl |
| I.49 | methyl | propyl | n-hexyl |
| I.50 | amino | propyl | n-hexyl |
| I.51 | methyl | isopropyl | isopropyl |
| I.52 | amino | isopropyl | isopropyl |
| I.53 | methyl | isopropyl | butyl |
| I.54 | amino | isopropyl | butyl |
| I.55 | methyl | isopropyl | n-pentyl |
| I.56 | amino | isopropyl | n-pentyl |
| I.57 | methyl | isopropyl | n-hexyl |
| I.58 | amino | isopropyl | n-hexyl |
| I.59 | methyl | butyl | butyl |
| I.60 | amino | butyl | butyl |
| I.61 | methyl | butyl | n-pentyl |
| I.62 | amino | butyl | n-pentyl |
| I.63 | methyl | butyl | n-hexyl |
| I.64 | amino | butyl | n-hexyl |
| I.65 | methyl | n-pentyl | n-pentyl |
| I.66 | amino | n-pentyl | n-pentyl |
| I.67 | methyl | n-pentyl | n-hexyl |
| I.68 | amino | n-pentyl | n-hexyl |
| I.69 | methyl | n-hexyl | n-hexyl |
| I.70 | amino | n-hexyl | n-hexyl |

| | | |
|---|---|---|
| I.71 | methyl | —(CH₂)₄— |
| I.72 | amino | —(CH₂)₄— |
| l.73 | methyl | —(CH₂)₂—O—(CH₂)₂— |
| I.74 | amino | —(CH₂)₂—O—(CH₂)₂— |

Compounds I.1, I.3, I.5, I.7, I.9, I.11 and I.13 are particularly preferred.

Component B may be tribenuron, an agriculturally acceptable derivative thereof, an agriculturally acceptable salt of tribenuron or an agriculturally acceptable salt of said derivative. Suitable derivatives and salts are illustrated below.

Preferably, component B is selected from tribenuron, a C₁-C₁₀-alkylester thereof, an agriculturally acceptable salt of tribenuron or an agriculturally acceptable salt of said ester. The particularly preferred component B is tribenuron, tribenuron-methyl or an agriculturally acceptable salt thereof.

The combination of the 3-phenyluracils of formula I with component B may be used in combination with at least one (one or more) other herbicide (component C) or an agriculturally acceptable salt or derivative (provided the herbicide has a carboxyl group) thereof. The herbicides C are selected from the following classes c1) to c15):
c1) lipid biosynthesis inhibitors;
c2) acetolactate synthase inhibitors (ALS inhibitors);
c3) photosynthesis inhibitors;
c4) protoporphyrinogen-IX oxidase inhibitors;
c5) bleacher herbicides;
c6) enolpyruvyl shikimate 3-phosphate synthase inhibitors (EPSP inhibitors);
c7) glutamine synthetase inhibitors;
c8) 7,8-dihydropteroate synthase inhibitors (DHP inhibitors);
c9) mitose inhibitors;
c10) inhibitors of the synthesis of long chain fatty acids (VLCFA inhibitors);
c11) cellulose biosynthesis inhibitors;
c12) decoupler herbicides;
c13) auxin herbicides;
c14) auxin transport inhibitors;
c15) other herbicides selected from the group consisting of benzoylprop, flamprop, flamprop-M, bromobutide, chlorflurenol, cinmethylin, methyldymuron, etobenzanid, fosamine, metam, pyributicarb, oxaziclomefone, dazomet, triaziflam and methyl bromide;
   the agriculturally acceptable salts and the agriculturally acceptable derivatives thereof, provided they have a carboxyl group.

Preferred herbicides of groups c1) to c15) are the compounds listed below:
c1) from the group of the lipid biosynthesis inhibitors:
   chlorazifop, clodinafop, clofop, cyhalofop, diclofop, fenoxaprop, fenoxaprop-p, fenthiaprop, fluazifop, fluazifop-P, haloxyfop, haloxyfop-P, isoxapyrifop, metamifop, propaquizafop, quizalofop, quizalofop-P, trifop, alloxydim, butroxydim, clethodim, cloproxydim, cycloxydim, profoxydim, sethoxydim, tepraloxydim, tralkoxydim, butylate, cycloate, diallate, dimepiperate, EPTC, esprocarb, ethiolate, isopolinate, methiobencarb, molinate, orbencarb, pebulate, prosulfocarb, sulfallate, thiobencarb, tiocarbazil, triallate, vernolate, benfuresate, ethofumesate, bensulide and pinoxaden;
c2) from the group of the ALS inhibitors:
   amidosulfuron, azimsulfuron, bensulfuron, chlorimuron, chlorsulfuron, cinosulfuron, cyclosulfamuron, ethametsulfuron, ethoxysulfuron, flazasulfuron, flupyrsulfuron, foramsulfuron, halosulfuron, imazosulfuron, iodosulfuron, mesosulfuron, metsulfuron, nicosulfuron, oxasulfuron, primisulfuron, prosulfuron, pyrazosulfuron, rimsulfuron, sulfometuron, sulfosulfuron, thifensulfuron, triasulfuron, trifloxysulfuron, triflusulfuron, tritosulfuron, imazamethabenz, imazamox, imazapic, imazapyr, imazaquin, imazethapyr, cloransulam, diclosulam, florasulam, flumetsulam, metosulam, penoxsulam, bispyribac, pyriminobac, propoxycarbazone, flucarbazone, pyribenzoxim, pyriftalid, pyrithiobac, flucetosulfuron, orthosulfamuron, pyrimisulfan, [N-(5,7-dimethoxy[1,2,4]triazolo[1,5-a]pyrimidin-2-yl-2-methoxy-4-(trifluormethyl)-3-pyridinesulfonamide, known from WO 02/36595;
c3) from the group of the photosynthesis inhibitors:
   atraton, atrazine, ametryne, aziprotryne, cyanazine, cyanatryn, chlorazine, cyprazine, desmetryne, dimethametryne, dipropetryn, eglinazine, ipazine, mesoprazine, methometon, methoprotryne, procyazine, proglinazine, prometon, prometryne, propazine, sebuthylazine, secbumeton, simazine, simeton, simetryne, terbumeton, terbuthylazine, terbutryne, trietazine, ametridione, amibuzin, hexazinone, isomethiozin, metamitron, metribuzin, bromacil, isocil, lenacil, terbacil, brompyrazon, chloridazon, dimidazon, desmedipham, phenisopham, phenmedipham, phenmedipham-ethyl, benzthiazuron, buthiuron, ethidimuron, isouron, methabenzthiazuron, monoisouron, tebuthiuron, thiazafluoron, anisuron, buturon, chlorbromuron, chloreturon, chlorotoluron, chloroxuron, difenoxuron, dimefuron, diuron, fenuron, fluometuron, fluothiuron, isoproturon, linuron, methiuron, metobenzuron, metobromuron, metoxuron, monolinuron, monuron, neburon, parafluoron, phenobenzuron, siduron, tetrafluoron, thidiazuron, cyperquat, diethamquat, difenzoquat, diquat, morfamquat, paraquat, bromobonil, bromoxynil, chloroxynil, iodobonil, ioxynil, amicarbazone, bromofenoxim, flumezin, methazole, bentazone, propanil, pentanochlor, pyridate, and pyridafol;
c4) from the group of the protoporphyrinogen-IX oxidase inhibitors: acifluorfen, bifenox, chlomethoxyfen, chlornitrofen, ethoxyfen, fluorodifen, fluoroglycofen, fluoronitrofen, fomesafen, furyloxyfen, halosafen, lactofen, nitrofen, nitrofluorfen, oxyfluorfen, fluazolate, pyraflufen, cinidon-ethyl, flumiclorac, flumioxazin, flumipropyn, fluthiacet, thidiazimin, oxadiazon, oxadiargyl, azafenidin, carfentrazone, sulfentrazone, pentoxazone, benzfendizone, butafenacil, pyraclonil, profluazol, flufenpyr, flupropacil, nipyraclofen, etnipromid, and bencarbazone;
c5) from the group of the bleacher herbicides: metflurazon, norflurazon, flufenican, diflufenican, picolinafen, beflubutamid, fluridone, fluorochloridone, flurtamone, mesotrione, sulcotrione, isoxachlortole, isoxaflutole, benzofenap, pyrazolynate, pyrazoxyfen, benzobicyclon, amitrole, clomazone, aclonifen, 4-(3-trifluoromethylphenoxy)-2-(4-trifluoromethylphenyl)pyrimidine, known from EP 723960, topramezone, 4-hydroxy-3-{[2-methyl-6-(trifluoromethyl)-3-pyridinyl]carbonyl}-bicyclo[3.2.1]oct-3-en-2-one, known from WO 00/15615, 4-hydroxy-3-{[2-(2-methoxyethoxy)methyl-6-(trifluoro-methyl)-3-pyridinyl]carbonyl}bicylo[3.2.1]oct-3-en-2-one, known from WO 01/94339, 4-hydroxy-3-[4-(methylsulfonyl)-2-nitro-benzoyl]bicyclo[3.2.1]-oct-3-en-2-one, known from EP 338992, 2-[2-chloro-4-(methylsulfonyl)-3-[(2,2,2-trifluoroethoxy)methyl]benzoyl]-3-hydroxy-2-cyclo-hexen-1-one (known from DE 19846792), and pyrasulfotole;
c6) from the group of the EPSP synthase inhibitors: glyphosate;
c7) from the group of the glutamine synthase inhibitors: glufosinate and bilanaphos;
c8) from the group of the DHP synthase inhibitors: asulam;
c9) from the group of the mitose inhibitors:
   benfluralin, butralin, dinitramine, ethalfluralin, fluchloralin, isopropalin, methalpropalin, nitralin, oryzalin, pendimethalin, prodiamine, profluralin, trifluralin, amiprofos-methyl, butamifos, dithiopyr, thiazopyr, propyzamide, tebutam, chlorthal, carbetamide, chlorbufam, chlorpropham and propham;
c10) from the group of the VLCFA inhibitors: acetochlor, alachlor, butachlor, butenachlor, delachlor, diethatyl, dimethachlor, dimethenamid, dimethenamid-P, metazachlor, metolachlor, S-metolachlor, pretilachlor, propachlor, propisochlor, prynachlor, terbuchlor, thenylchlor, xylachlor, allidochlor, CDEA, epronaz, diphenamid, napropamide, naproanilide, pethoxamid, flufenacet, mefenacet, fentrazamide, anilofos, piperophos, cafenstrole, indanofan and tridiphane;
c11) from the group of the cellulose biosynthesis inhibitors: dichlobenil, chlorthiamid, isoxaben and flupoxam;
c12) from the group of the decoupler herbicides: dinofenate, dinoprop, dinosam, dinoseb, dinoterb, DNOC, etinofen and medinoterb;
c13) from the group of the auxin herbicides:
   clomeprop, 2,4-D, 2,4,5-T, MCPA, MCPA thioethyl, dichlorprop, dichlorprop-P, mecoprop, mecoprop-P, 2,4-DB, MCPB, chloramben, dicamba, 2,3,6-TBA, tricamba, quinclorac, quinmerac, clopyralid, fluoroxypyr, picloram, triclopyr, benazolin and aminopyralid;
c14) from the group of the auxin transport inhibitors: naptalam, diflufenzopyr;
c15) benzoylprop, flamprop, flamprop-M, bromobutide, chlorflurenol, cinmethylin, methyldymron, etobenzanid, fosamine, metam, pyributicarb, oxaziclomefone, dazomet, triaziflam, methyl bromide;
   the agriculturally acceptable salts and the agriculturally acceptable derivatives of the herbicides, provided they have a carboxyl group.

Most preferred herbicides are those of groups c1), c2), c3) and c13) in particular the compounds listed below:
c1) from the group of the lipid biosynthesis inhibitors:
   clodinafop, fenoxaprop, fenoxaprop-P, tralkoxydim and pinoxaden
c2) from the group of the ALS inhibitors:
   thifensulfuron, triasulfuron, chlorsulfon, metsulfuron, prosulfuron, sulfosulfuron, mesosulfuron, propoxycarbazone, flucarbazone, imazamethabenz, imazamox, imazapic, imazapyr, imazaquin, imazethapyr, and [N-(5,7-dimethoxy[1,2,4]triazolo[1,5-a]pyrimidin-2-yl-2-methoxy-4-(trifluormethyl)-3-pyridinesulfonamide;
c3) from the group of photosynthesis inhibitors:
   bromoxynil and ioxynil;
c13) from the group of the auxin herbicides:
   2,4-D, MCPA, dichlorprop, dichlorprop-P, mecoprop, mecoprop-P, dicamba, clopyralid, fluoroxypyr and aminopyralid;

Tribenuron and the herbicides C of groups c1) to c15) are known herbicides, see the quoted literature references and, for example, The Compendium of Pesticide Common Names (http://www.hclrss.demon.co.uk/index.html); Farm Chemicals Handbook 2000 Vol. 86, Meister Publishing Company, 2000; B. Hock, C. Fedtke, R. R. Schmidt, Herbizide, Georg Thieme Verlag, Stuttgart 1995; W. H. Ahrens, Herbicide Handbook, 7^{th} Edition, Weed Science Society of America, 1994; and K. K. Hatzios, Herbicide Hand-book, Supplement to 7^{th} Edition, Weed Science Society of America, 1998. 2,2,5-Trimethyl-3-(dichloroacetyl)-1,3-oxazolidine [CAS No. 52836-31-4] is also known under the name R-29148. 4-(Dichloroacetyl)-1-oxa-4-azaspiro[4.5]decane [CAS No. 71526-07-03] is also known under the names AD-67 and MON 4660.

The categorization of the active compounds according to their mode of action is based on current understanding. If an active compound acts by more than one mode of action, this substance was assigned to only one mode of action.

If the phenyluracils I and/or the herbicides C are capable of forming geometrical isomers, for example E/Z isomers, it is possible to use both the pure isomers and mixtures thereof in the compositions according to the invention. If the phenyluracils I and/or the herbicides C have one or more centers of chirality and, as a consequence, are present as enantiomers or diastereomers, it is possible to use both the pure enantiomers and diastereomers and their mixtures in the compositions according to the invention.

If the phenyluracils I and/or the herbicides C have functional groups which can be ionized, they can also be used in the form of their agriculturally acceptable salts. Also tribenuron has such functional groups and can therefore be used in the form of such salts. In general, the salts of those cations or the acid addition salts of those acids are suitable whose cations and anions, respectively, have no adverse effect on the action of the active compounds. The same is applicable with regard to tribenuron and/or its derivatives such as tribenuron-methyl.

Preferred cations are the ions of the alkali metals, preferably of lithium, sodium and potassium, of the alkaline earth metals, preferably of calcium and magnesium, and of the transition metals, preferably of manganese, copper, zinc and iron, furthermore ammonium and substituted ammonium in which one to four hydrogen atoms are replaced by C₁-C₄-alkyl, hydroxy-C₁-C₄-alkyl, C₁-C₄-alkoxy-C₁-C₄-alkyl, hydroxy-C₁-C₄-alkoxy-C₁-C₄-alkyl, phenyl or benzyl, preferably ammonium, methylammonium, isopropylammonium, dimethylammonium, diisopropylammonium, trimethylammonium, tetramethyl-ammonium, tetraethylammonium, tetrabutylammonium, 2-hydroxyethylammonium, 2-(2-hydroxyethoxy)eth-1-ylammonium, di(2-hydroxyeth-1-yl)ammonium, benzyl-trimethylammonium, benzyltriethylammonium, furthermore phosphonium ions, sulfonium ions, preferably tri(C₁-C₄-alkyl)sulfonium such as trimethylsulfonium, and sulfoxonium ions, preferably tri(C₁-C₄-alkyl)sulfoxonium.

It is possible to use the active compounds of the formula I, tribenuron and at least one herbicide C selected from chlorazifop, clodinafop, clofop, cyhalofop, diclofop, fenoxaprop, fenoxaprop-P, fenthiaprop, fluazifop, fluazifop-P, haloxyfop, haloxyfop-P, isoxapyrifop, propaquizafop, quizalofop, quizalofop-P, trifop, alloxydim, butroxydim, clethodim, cloproxydim, cycloxydim, profoxydim, sethoxydim, tepraloxydim, tralkoxydim, amidosulfuron, azimsulfuron, bensulfuron, chlorimuron, chlorsulfuron, cinosulfuron, cyclosulfamuron, ethametsulfuron, ethoxysulfuron, flazasulfuron, flupyrsulfuron, foramsulfuron, halosulfuron, imazosulfuron, iodosulfuron, mesosulfuron, metsulfuron, nicosulfuron, oxasulfuron, primisulfuron, prosulfuron, pyrazosulfuron, rimsulfuron, sulfometuron, sulfosulfuron, thifensulfuron, triasulfuron, trifloxysulfuron, triflusulfuron, tritosulfuron, propoxycarbazon, flucarbazon, imazamethabenz, imazamox, imazapic, imazapyr, imazaquin, imazethapyr, cloransulam, diclosulam, florasulam, flumetsulam, metosulam, penoxsulam, bispyribac, pyrithiobac, flucetosulfuron, orthosulfamuron, pyrimisulfam, [N-(5,7-dimethoxy[1,2,4]triazolo[1,5-a]-pyrimidin-2-yl-2-methoxy-4-(trifluoromethyl)-3-pyridinsulfonamide, pyriminobac, bentazon, acifluorfen, ethoxyfen, fluoroglycofen, fomesafen, halosafen, lactofen, pyraflufen, flumiclorac, fluthiacet, carfentrazone, flufenpyr, mesotrione, sulcotrione, topramezone, 4-hydroxy-3-{[2-methyl-6-(trifluoromethyl)-3-pyridinyl]carbonyl}bicylo-[3.2.1]oct-3-en-2-one, 4-hydroxy-3-{[2-(2-methoxyethoxy)methyl-6-(trifluoromethyl)-3-pyridinyl]carbonyl}bicyclo[3.2.1]oct-3-en-2-one, 4-hydroxy-3-[4-(methylsulfonyl)-2-nitrobenzoyl]-bicyclo[3.2.1]oct-3-en-2-one, 2-[2-chloro-4-(methylsulfonyl)-3-[(2,2,2-trifluoroethoxy)methyl]benzoyl]-3-hydroxy-2-cyclohexen-1-one, pyrasulfotole, glyphosate, glufosinate, bilanaphos, clomeprop, 2,4-D, 2,4 DB, dichlorprop, dichlorprop-P, MCPA, MCPB, mecoprop, mecoprop-P, 2,4,5-T, chloramben, dicamba, 2,3,6-TBA, tricamba, quinclorac, quinmerac, clopyralid, fluroxypyr, picloram, triclopyr, aminopyralid, naptalam, diflufenzopyr, cloquintocet, fenchlorazole, isoxadifen and mefenpyr, in the form of salts with the agriculturally useful cations mentioned above.

Anions of useful acid addition salts are primarily chloride, bromide, fluoride, iodide, hydrogen sulfate, methyl sulfate, sulfate, dihydrogen phosphate, hydrogen phosphate, nitrate, dicarbonate, carbonate, hexafluorosilicate, hexafluorophosphate, benzoate and the anions of C₁-C₄-alkanoic acids, preferably formate, acetate, propionate and butyrate.

According to the invention, the herbicides cyperquat, diethamquat, difenzoquat, diquat, morfamquat and paraquat are usually employed in the form of salts with the agriculturally useful anions mentioned above.

According to the invention, the active compounds which carry a carboxyl group can, instead of the active compounds mentioned above, also be employed in the form of an agriculturally acceptable derivative, for example as amides such as mono- or di-C₁-C₆-alkylamides or arylamides, as esters, for example as allyl esters, propargyl esters, C₁-C₁₀-alkyl esters or alkoxyalkyl esters, and also as thioesters, for example as C₁-C₁₀-alkyl thioesters. Examples of active compounds having a COOH group which can also be employed as derivatives are: tribenuron, chlorazifop, clodinafop, clofop, cyhalofop, diclofop, fenoxaprop, fenoxaprop-P, fenthiaprop, fluazifop, fluazifop-P, haloxyfop, haloxyfop-P, isoxapyrifop, propaquizafop, quizalofop, quizalofop-P, trifop, bensulfuron, chlorimuron, ethametsulfuron, flupyrsulfuron, halosulfuron, iodosulfuron, mesosulfuron, metsulfuron, primisulfuron, pyrazosulfuron, sulfometuron, thifensulfuron, tribenuron, triflusulfuron, imazamethabenz, imazamox, imazapic, imazapyr, imazaquin, imazethapyr, cloransulam, bispyribac, pyrithiobac, pyriminobac, acifluorfen, ethoxyfen, fluoroglycofen, lactofen, pyraflufen, flumiclorac, fluthiacet, carfentrazone, flufenpyr, clomeprop, 2,4-D, 2,4-DB, dichlorprop, dichlorprop-P, MCPA, MCPB, mecoprop, mecoprop-P, 2,4,5-T, chloramben, dicamba, 2,3,6-TBA, tricamba, quinclorac, quinmerac, clopyralid, fluoroxypyr, picloram, triclopyr, aminopyralid, naptalam, diflufenzopyr, cloquintocet, fenchlorazole, isoxadifen and mefenpyr.

Preferred mono- and di-C₁-C₆-alkylamides are the methyl- and the dimethylamides. Preferred arylamides are, for example, the anilidines and the 2-chloroanilides. Preferred alkyl esters are, for example, the methyl, ethyl, propyl, isopropyl, butyl, isobutyl, pentyl, mexyl (1-methylhexyl) or isooctyl (2-ethylhexyl) esters. Preferred C₁-C₄-alkoxy-C₁-C₄-alkyl esters are the straight-chain or branched C₁-C₄-alkoxyethyl esters, for ex-ample the methoxyethyl, ethoxyethyl or butoxyethyl esters. An example of the straight-chain or branched C₁-C₁₀-alkyl thioesters is the ethyl thioester.

In case of tribenuron, the esters and in particular the C₁-C₁₀-alkyl esters, more particularly the C₁-C₆-alkyl esters, are preferred. The most preferred tribenuron derivative is the methyl ester, i.e. tribenuron-methyl.

According to the invention binary and ternary compositions are used comprising at least one 3-phenyluracil of formula I as active compound A in combination with component B and optionally with at least one herbicide C.

Here and below, the term “binary compositions” includes compositions which comprise one or more, for example 2 or 3, active compounds A, and component B. Correspondingly, the term “ternary compositions” includes compositions which comprise one or more, for example 2 or 3, active compounds A, component B and one or more, for example 2 or 3, herbicides C.

In binary compositions which comprise at least one 3-phenyluracil of the formula I and component B, the weight ratio of the active compounds A:B is usually in the range from 1:100 to 10:1, preferably from 1:50 to 10:1 and in particular in the range from 1:25 to 5:1.

In ternary compositions which comprise both a 3-phenyluracil I as component A, component B and at least one herbicide C, the relative weight ratios of the components A:B:C are usually in the range from 10:1:1 to 1:10:500, preferably from 10:1:1 to 1:10:100, in particular from 10:1:1 to 1:1:50 and particularly preferably from 5:1:1 to 1:25:5. In these ternary compositions, the weight ratio of herbicide C to component B is preferably in the range from 50:1 to 1:10.

In a particularly preferred embodiment of the invention, preference is given to those compositions of the invention which comprise a 3-phenyluracil of the formula I, especially of formulae Ia or Ib, in combination with component B and optionally at least one and especially exactly one herbicidally active compound of the group c1), in particular selected from the group consisting of clodinafop, fenoxaprop, fenoxaprop-P, tralkoxydim and pinoxaden.

In another particularly preferred embodiment of the invention, preference is given to those compositions of the invention which comprise a 3-phenyluracil of the formula I, especially of formulae Ia or Ib, in combination with component B and optionally at least one and especially exactly one herbicidally active compound of the group c2), in particular selected from the group consisting of chlorsulfuron, mesosulfuron, metsulfuron, prosulfuron, sulfosulfuron, propoxycarbazone, flucarbazone, imazamethabenz, imazamox, imazapic, imazapyr, imazaquin, imazethapyr, thifensulfuron, triasulfuron and [N-(5,7-dimethoxy[1, 2,4]triazolo[1,5-a]pyrimidin-2-yl-2-methoxy-4-(trifluoromethyl)-3-pyridinesulfonamide.

In another particularly preferred embodiment of the invention, preference is given to those compositions of the invention which comprise a 3-phenyluracil of the formula I, especially of formulae Ia or Ib, in combination with component B and optionally at least one and especially exactly one herbicidally active compound of the group c3), in particular selected from the group consisting of bromoxynil and ioxynil.

In another particularly preferred embodiment of the invention, preference is given to those compositions of the invention which comprise a 3-phenyluracil of the formula I, especially of formulae Ia or Ib, in combination with component B and optionally at least one and especially exactly one herbicidally active compound of the group c13), in particular selected from the group consisting of 2,4-D, dichlorprop, dichlorprop-P, mecoprop, MCPA, mecoprop-P, dicamba, clopyralid, fluoroxypyr and aminopyralid.

For application ready-to-use preparations in the form of crop protection products can be employed. Component A, component B and optionally component C may be present in suspended, emulsified or dissolved form and can be formulated jointly or separately. The application forms depend entirely on the intended use.

The preparations can be applied, for example, in the form of directly sprayable aqueous solutions, powders, suspensions, also highly-concentrated aqueous, oily or other suspensions or dispersions, emulsions, oil dispersions, pastes, dusts, materials for spreading or granules, by means of spraying, atomizing, dusting, broadcasting or watering. The use forms depend on the intended use; in any case, they should ensure the finest possible distribution of the active compounds.

Depending on the form in which the ready-to-use preparations are present, they comprise one or more liquid or solid carriers, if appropriate surfactants and if appropriate further auxiliaries which are customary for formulating crop protection products. The person skilled in the art is sufficiently familiar with the recipes for such formulations.

The ready-to-use preparations may comprise auxiliaries which are customary formulating crop protection products, which auxiliaries may also comprise a liquid carrier.

Suitable inert additives with carrier function are essentially: mineral oil fractions of medium to high boiling point, such as kerosene and diesel oil, furthermore coal tar oils and oils of vegetable or animal origin, aliphatic, cyclic and aromatic hydrocarbons, e.g. paraffins, tetrahydronaphthalene, alkylated naphthalenes and their derivatives, alkylated benzenes and their derivatives, alcohols such as methanol, ethanol, propanol, butanol and cyclohexanol, ketones such as cyclohexanone, strongly polar solvents, e.g. amines such as N-methylpyrrolidone, and water.

Aqueous use forms can be prepared from emulsion concentrates, suspensions, pastes, wettable powders or water-dispersible granules by adding water. To prepare emulsions, pastes or oil dispersions, the active compound(s) as such or dissolved in an oil or solvent, can be homogenized in water by means of wetting agent, tackifier, dispersant or emulsifier. Alternatively, it is possible to prepare concentrates consisting of active substance, wetting agent, tackifier, dispersant or emulsifier and, if desired, solvent or oil, and these concentrates are suitable for dilution with water.

Suitable surfactants are the alkali metal salts, alkaline earth metal salts and ammonium salts of aromatic sulfonic acids, e.g. ligno-, phenol-, naphthalene- and dibutylnaphthalenesulfonic acid, and of fatty acids, of alkyl- and alkylarylsulfonates, of alkyl sulfates, lauryl ether sulfates and fatty alcohol sulfates, and salts of sulfated hexa-, hepta- and octadecanols and of fatty alcohol glycol ethers, condensates of sulfonated naphthalene and its derivatives with formaldehyde, condensates of naphthalene or of the naphthalenesulfonic acids with phenol and formaldehyde, polyoxyethylene octylphenol ether, ethoxylated isooctyl-, octyl- or nonylphenol, alkylphenyl polyglycol ethers, tributylphenyl polyglycol ether, alkylaryl polyether alcohols, isotridecyl alcohol, fatty alcohol/ethylene oxide condensates, ethoxylated castor oil, polyoxyethylene alkyl ether or polyoxypropylene alkyl ether, lauryl alcohol polyglycol ether acetate, sorbitol esters, lignosulfite waste liquors or methylcellulose.

Powders, materials for spreading and dusts can be prepared by mixing or concomitant grinding of the active substances with a solid carrier.

Granules, e.g. coated granules, impregnated granules and homogeneous granules, can be prepared by binding the active ingredient (s) to solid carriers. Solid carriers are mineral earths such as silicas, silica gels, silicates, talc, kaolin, limestone, lime, chalk, bole, loess, clay, dolomite, diatomaceous earth, calcium sulfate, magnesium sulfate, magnesium oxide, ground synthetic materials, fertilizers such as ammonium sulfate, ammonium phosphate, ammonium nitrate, ureas, and products of vegetable origin such as cereal meal, tree bark meal, wood meal and nutshell meal, cellulose powders, or other solid carriers.

The concentrations of the active compound(s) in the ready-to-use preparations can be varied within wide ranges. In general, the formulations comprise from 0.001 to 98% by weight, preferably 0.01 to 95% by weight, of active ingredient (s). The active ingredient (s) are employed in a purity of from 90% to 100%, preferably 95% to 100% (according to NMR spectrum).

The preparations can, for example, be formulated as follows:
I 20 parts by weight of the active compound(s) in question are dissolved in a composition composed of 80 parts by weight of alkylated benzene, 10 parts by weight of the adduct of 8 to 10 mol of ethylene oxide to 1 mol of oleic acid N-monoethanolamide, 5 parts by weight of calcium dodecylbenzenesulfonate and 5 parts by weight of the adduct of 40 mol of ethylene oxide to 1 mol of castor oil. Pouring the solution into 100 000 parts by weight of water and finely distributing it therein gives an aqueous dispersion which comprises 0.02% by weight of the active ingredient.
II 20 parts by weight of the active compound(s) in question are dissolved in a composition composed of 40 parts by weight of cyclohexanone, 30 parts by weight of isobutanol, 20 parts by weight of the adduct of 7 mol of ethylene oxide to 1 mol of isooctylphenol and 10 parts by weight of the adduct of 40 mol of ethylene oxide to 1 mol of castor oil. Pouring the solution into 100 000 parts by weight of water and finely distributing it therein gives an aqueous dispersion which comprises 0.02% by weight of the active ingredient.
III 20 parts by weight of the active compound(s) in question are dissolved in a composition composed of 25 parts by weight of cyclohexanone, 65 parts by weight of a mineral oil fraction of boiling point 210 to 280° C. and 10 parts by weight of the adduct of 40 mol of ethylene oxide to 1 mol of castor oil. Pouring the solution into 100 000 parts by weight of water and finely distributing it therein gives an aqueous dispersion which comprises 0.02% by weight of the active ingredient.
IV 20 parts by weight of the active compound(s) in question are mixed thoroughly with 3 parts by weight of sodium diisobutylnaphthalenesulfonate, 17 parts by weight of the sodium salt of a lignosulfonic acid from a sulfite waste liquor and 60 parts by weight of pulverulent silica gel, and the composition is ground in a hammer mill. Finely distributing the composition in 20 000 parts by weight of water gives a spray composition which comprises 0.1% by weight of the active ingredient.
V 3 parts by weight of the active compound(s) in question are mixed with 97 parts by weight of finely divided kaolin. This gives a dust which comprises 3% by weight of the active ingredient.
VI 20 parts by weight of the active compound(s) in question are mixed intimately with 2 parts by weight of calcium dodecylbenzenesulfonate, 8 parts by weight of fatty alcohol polyglycol ether, 2 parts by weight of the sodium salt of a phenolurea-formaldehyde condensate and 68 parts by weight of a paraffinic mineral oil. This gives a stable oily dispersion.
VII 1 part by weight of the active compound(s) in question is dissolved in a composition composed of 70 parts by weight of cyclohexanone, 20 parts by weight of ethoxylated isooctylphenol and 10 parts by weight of ethoxylated castor oil. This gives a stable emulsion concentrate.
VII 1 part by weight of the active compound(s) in question is dissolved in a composition composed of 80 parts by weight of cyclohexanone and 20 parts by weight of Wettol EM 31 (nonionic emulsifier based on ethoxylated castor oil). This gives a stable emulsion concentrate.

The components A, B and C can be formulated jointly or separately.

The components A, B and C can be applied jointly or separately, simultaneously or successively, before, during or after emergence of the plants.

If the active compound(s) are less well tolerated by certain crop plants, it is possible to use application methods in which the herbicidal compositions are sprayed with the aid of sprayers in such a way that the leaves of the sensitive crop plants are as far as possible unaffected, whereas the active compounds reach the leaves of the undesirable plants growing underneath or the uncovered soil surface (post-directed, lay-by).

The required application rate of the pure active compounds, i.e. of component A, in combination with component B and/or optionally in combination with component C without formulation auxiliary, depends on the density of the undesired vegetation, on the development stage of the plants, on the climatic conditions of the location where the composition is used and on the application method. In general, the application rate is from 0.001 to 3 kg/ha, preferably from 0.005 to 2 kg/ha and in particular from 0.01 to 1 kg/ha, from 0.1 g/ha to 1 kg/ha, from 1 g/ha to 500 g/ha or from 5 g/ha to 500 g/ha of active substance.

The preparations are applied to the plants mainly by spraying, in particular foliar spraying. Application can be carried out by customary spraying techniques using, for example, water as carrier and spray liquid rates of from about 50 to 1 000 l/ha (for example from 300 to 400 l/ha). Application of the preparations by the low-volume and the ultra-low-volume method is possible, as is their application in the form of microgranules.

Moreover, it may be useful to apply the compositions according to the invention jointly as a mixture with other crop protection products, for example with pesticides or agents for controlling phytopathogenic fungi or bacteria. Also of interest is the miscibility with mineral salt solutions which are employed for treating nutritional and trace element deficiencies. Non-phytotoxic oils and oil concentrates may also be added.

According to a preferred embodiment, the invention provides for weed control in wheat, oat, barley or rye.

The weed control according to the present invention may be provided in transgenic or resistant small-grain cereals, in particular wheat. More preferably, the transgenic or resistant crop of small-grain cereals may be a glyphosate resistant crop, an oxynil resistant crop, a glufosinate resistant crop, an imidazolinone resistant crop, a sulfonylurea resistant crop, a dicamba tolerant crop, a cyclohexanedione resistant crop, a PPO resistant crop, an HPPD resistant crop, a fungus resistant crop, an insect resistant crop, or a crop which by means of multiple changes of the genome (“stacked traits”) exhibits more than one of said resistance properties. Most preferably, the crop is a glyphosate resistant crop, an imidazolinone resistant crop or a crop which by means of multiple changes of the genome (“stacked traits”) is both a glyphosate and/or imidazolinone resistant and/or a fungus resistant crop.

The weed control according to the present invention can be provided in crops which are resistant to one or more herbicides and/or which are resistant to the attack of fungi and/or which are resistant to the attack of insects, whereby resistance may be conferred by genetic engineering. For example, by said techniques such crops may have acquired the capability to synthesize (i) one or more selectively acting toxins, in particular fungicidal toxins or insecticidal toxins, such as those which are known from toxin producing bacteria, especially those of the genus bacillus, for example endotoxins, e.g. CryIA(b), CryIA(c), CryIF, CryIF(a2), CryIIA(b), CryIIIA, CryIIB(b1), Cry9c, VIP1, VIP2, VIP3 or VIP3A or hybrids (i.e. combinations of different domains of such toxins), modifications (by replacement of one or more of the amino acids as compared to the naturally occurring sequence, e.g. CryIIIA055) and/or truncated versions thereof, and/or (ii) an altered amount of an enzyme which is the target of a herbicide, and/or (iii) a modified form of an enzyme which is the target of a herbicide, and/or (iv) one or more enzymes which are alone or together capable of converting a herbicide into a chemical which is not toxic to the plant and/or (v) antipathogenic substances, such as, for example, the so-called “pathogenesis-related proteins”. Such crops are illustrated by, but not limited to, the examples described in the following table, which are commercially available or known to the person skilled in the art or described in the quoted publications, and by any other examples which arise from stacking more than one of the traits listed in table 2. Amongst the traits listed in table 2, those are preferred which provide imidazolinone and/or glyphosate and/or fungus resistance.

TABLE 2

| | | | |
|---|---|---|---|
| Wheat | AP205CL | Imidazolinone resis- | 1) |
| | | tant crop | |
| Wheat | AP602CL | Imidazolinone resis- | 1) |
| | | tant crop | |
| Wheat | MON71800 | Glyphosate resistant | 1) |
| | | crop | |
| Wheat | SWP965001 | Imidazolinone resis- | 1) |
| | | tant crop | |
| Wheat | Teal 11A, TealIMI | Imidazolinone resis- | 1), 3) |
| | 11A | tant crop | |
| Wheat | Several | Imidazolinone resis- | 4) |
| | | tant crop | |
| Wheat | Clearfield ® | Imidazolinone resis- | 4) |
| | | tant crop | |
| Wheat | FS1 | Imidazolinone resis- | 4) |
| | | tant crop | |
| Wheat | FS2 | Imidazolinone resis- | 4) |
| | | tant crop | |
| Wheat | FS3 | Imidazolinone resis- | 4) |
| | | tant crop | |
| Wheat | FS4 | Imidazolinone resis- | 4) |
| | | tant crop | |
| Any | Dicamba-degrading | Dicamba resistant | 4) |
| | enzymes | crop | |
| Any | HPPD resistance | HPPD resistant crop | 5) |
| | genes | | |
| Any | | Fungus resistant | e.g. 2) and refer- |
| | | plants | ences quoted |
| | | | therein (EP 392225, |
| | | | WO 95/33818, EP |
| | | | 353191, WO |
| | | | 03/00906) |

1) http://www.agbios.com/dbase.php#
2) WO 05/13696
3) S. Tan, R. Evans, M. Dahmer, B. Singh, D. Shaner, Pest Manag. Sci. 2005, 61, 246-257 and references cited therein
4) WO 98/45424; WO 02/68607
5) M. Matringe, A. Sailland, B. Pelissier, A. Rolland, O. Zink, Pest Manag. Sci, 2005, 61, 269-276 and references cited therein; WO 96/38567; WO 98/04685; WO 99/24585; WO 99/25842

The following examples illustrate the invention without limiting it.

### EXAMPLES

The effect of the use of safened herbicidal combinations according to the present invention on the growth of crop plants and/or undesired plants was demonstrated by field tests (examples 1-2).

The phenyluracils I and/or the other active ingredients according to the present invention were formulated in a suitable way, either separately or in mixture, e.g. as emulsifiable concentrates (EC), soluble concentrates (SL), suspo-emulsions (SE), suspension concentrates (SC) or water-dispersible granules (WG). The formulation(s) were suspended or emulsified in water as a distribution medium immediately prior to spraying. Afterwards, the aqueous mixture was evenly sprayed on the test plots by means of finely distributing nozzles.

The test plots were of uniform size (typically between 14 and 37 square meters, each) and the distribution of treated and untreated plots was organized according to a randomised bloc design. Crops were sown in rows at a season which was typical for the region and the crop according to usual farm practice. Weeds were not sown but germinated according to the natural infestation.

For pre-plant and pre-plant burn-down treatments, the plots were treated before the crop was planted, typically 7 to 28 days prior to planting. For pre-emergence treatments, the plots were treated at planting (plus or minus two days) but before emergence. For post-emergence or in-crop treatments, the plots were treated after the emergence of the weed or crop, typically 20 to 50 days after planting.

The evaluation of the damage caused by the phenyluracils I and/or the other active ingredients according to the present invention was carried out using a scale from 0 to 100%, compared to the untreated control plots. Here, 0 means no damage and 100 means complete destruction of the plants of a respective weed or crop species.

A safener action is present if the damage to the crop plant caused by using a mixture according to the present invention which contains tribenuron-methyl is less than the damage caused when the phenyluracil I optionally in mixture with the other herbicides according to the present invention is used without tribenuron-methyl.

### Example 1

### Safening effect of tribenuron-methyl on the phenyluracil I.7 in wheat, oat and barley as well as associated weed control; post-emergence application; 15 DAT; field test

The results are shown in the following table 3.

TABLE 3

| | | | | | Weed control (% control) | | | |
|---|---|---|---|---|---|---|---|---|
| | | | | | Wild mustard | | Curly dock | |
| | | Phytotoxicity in small-grain | | | (SINAR) | | (RUMCR) | |
| Use rate (g/ha) | | cereal crops (% damage) | | | | Calculated | | Calculated |
| Phenyl- | Tri- | Spring | Spring | | | according to | | according to |
| uracil | benuron- | wheat | barley | Oat | | Colby's | | Colby's |
| I.7 | methyl | (TRZAS) | (HORVS) | (AVESA) | Found | equation | Found | equation |
| 12.5 | — | 12 | 8 | 8 | 100 | — | 32 | — |
| — | 10 | 0 | 0 | 0 | 100 | — | 40 | — |
| 12.5 | 10 | 9 | 3 | 4 | 100 | 100 | 70 | 59 |

In this example, Phenyluracil I.7 was formulated as a 120 g/l EC, and tribenuron-methyl as a 75% WG. Prior to application, the formulated active ingredients were tank-mixed with an aqueous 100 l/ha spray solution which contained, in addition, 10 g/l of Assist oil concentrate. The cereal crops were planted 27 days before treatment.

### Example 2

### Safening effect of tribenuron-methyl on the phenyluracil I.7 in wheat, oat and barley; post-emergence application; 3 DAT; field test

The results are shown in the following table 4.

TABLE 4

| | | Phytotoxicity in small-grain cereal | | |
|---|---|---|---|---|
| Use rate (g/ha) | | crops (% damage) | | |
| Phenyluracil | Tribenuron- | Spring wheat | Spring barley | Oat |
| I.7 | methyl | (TRZAS) | (HORVS) | (AVESA) |
| 12.5 | — | 25 | 25 | 25 |
| — | 10 | 1 | 1 | 5 |
| 12.5 | 10 | 10 | 10 | 11 |

In this example, Phenyluracil I.7 was formulated as a 120 g/l EC, and tribenuron-methyl as a 75% WG. Prior to application, the formulated active ingredients were tank-mixed with an aqueous 100 l/ha spray solution which contained, in addition, 10 g/l of Assist oil concentrate. The cereal crops were planted 27 days before treatment.

1-16. (canceled)

17. A method of controlling weeds in crops selected from small-grain cereals which comprises applying a herbicidally effective amount of a combination of one or more 3-phenyluracils (component A) of formula I 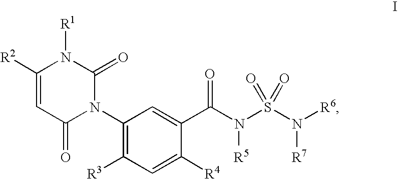
wherein:
R¹ is methyl or NH₂;
R² is C₁-C₂-haloalkyl;
R³ is hydrogen or halogen;
R⁴ is halogen or cyano;
R⁵ is hydrogen or C₁-C₆-alkyl;
R⁶, R⁷ independently of one another are hydrogen, C₁-C₆-alkyl, C₁-C₆-alkoxy, C₃-C₆-alkenyl, C₃-C₆-alkynyl, C₃-C₇-cycloalkyl, C₃-C₇-cycloalkenyl, phenyl or benzyl;
or an agriculturally acceptable salt thereof, with tribenuron, an agriculturally acceptable derivative thereof or an agriculturally acceptable salt of tribenuron or of said derivative (component B) to crops or weeds or their habitat.

18. The method of claim 17, wherein:
R¹ is methyl or NH₂;
R² is trifluoromethyl;
R³ is hydrogen, fluorine or chlorine;
R⁴ is halogen or cyano;
R⁵ is hydrogen;
R⁶, R⁷ independently of one another are hydrogen, C₁-C₆-alkyl, C₃-C₆-alkenyl, C₃-C₆-alkynyl, C₃-C₇-cycloalkyl, C₃-C₇-cycloalkenyl, phenyl or benzyl.

19. The method of claim 17, wherein R⁶ and R⁷ are identical or different C₁-C₆-alkyl radicals.

20. The method of claim 17, wherein component B is selected from tribenuron, a C₁-C₁₀-alkyl ester thereof or an agriculturally acceptable salt thereof.

21. The method of claim 20, wherein component B is selected from tribenuron, tribenuron-methyl or an agriculturally acceptable salt thereof.

22. The method of claim 17, wherein the crop is selected from wheat, oat, barley or rye.

23. The method of claim 17, wherein the 3-phenyluracil of formula I and component B are used in combination with one or more other herbicides (component C) or agriculturally acceptable salts thereof.

24. The method of claim 23, wherein the other herbicide C is selected from herbicides of the following classes c1) to c15) having a carboxyl group, or an agriculturally acceptable salt or derivative thereof:
c1) lipid biosynthesis inhibitors;
c2) acetolactate synthase inhibitors (ALS inhibitors);
c3) photosynthesis inhibitors;
c4) protoporphyrinogen-IX oxidase inhibitors;
c5) bleacher herbicides;
c6) enolpyruvyl shikimate 3-phosphate synthase inhibitors (EPSP inhibitors);
c7) glutamine synthetase inhibitors;
c8) 7,8-dihydropteroate synthase inhibitors (DHP inhibitors);
c9) mitose inhibitors;
c11) inhibitors of the synthesis of long chain fatty acids (VLCFA inhibitors);
c12) cellulose biosynthesis inhibitors;
c13) decoupler herbicides;
c14) auxin transport inhibitors;
c15) other herbicides selected from the group consisting of benzoylprop, flamprop, flamprop-M, bromobutide, chlorflurenol, cinmethylin, methyldymuron, etobenzanid, fosamine, metam, pyributicarb, oxaziclomefone, dazomet, triazflam and methyl bromide.

25. The method of claim 17, wherein the 3-phenyluracil in combination with component B and optionally said other herbicide C are applied post-emergence to the crop.

26. The method of claim 17, wherein the method is used for controlling weeds in herbicide resistant and/or fungus resistant small-grain cereal crops.

27. The method of claim 26, wherein the herbicide resistant crop is a Glyphosate resistant crop.

28. The method of claim 26, wherein the herbicide resistant and/or fungus resistant crop is wheat.

29. The method of claim 27, wherein the herbicide resistant and/or fungus resistant crop is wheat.

30. The method of claim 26, wherein the herbicide resistant crop is an imidazolinone resistant crop.

31. The method of claim 28, wherein the herbicide resistant crop is an imidazolinone resistant crop.

32. A method of safening the phytotoxic activity of a 3-phenyluracil of formula I 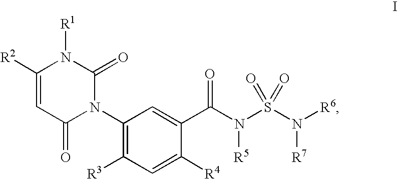
wherein:
R¹ is methyl or NH₂;
R² C₁-C₂-haloalkyl;
R³ is hydrogen or halogen;
R⁴ is halogen or cyano;
R⁵ is hydrogen or C₁-C₆-alkyl;
R⁶, R⁷ independently of one another are hydrogen, C₁-C₆-alkyl, C₁-C₆-alkoxy, C₃-C₆-alkenyl, C₃-C₆-alkynyl, C₃-C₇-cycloalkyl, C₃-C₇-cycloalkenyl, phenyl or benzyl;
or an agriculturally acceptable salt thereof on crops selected from small-grain cereals wherein the method comprises using said 3-phenyluracil in combination with tribenuron, an agriculturally acceptable derivative thereof or an agriculturally acceptable salt of tribenuron or of said derivative (component B), in an amount effective to reduce or eliminate the phytotoxic activity of said 3-phenyluracil.
